(19) United States
(12) Patent Application Publication
(10) Pub. No.: US 2018/0314051 A1
(43) Pub. Date: Nov. 1, 2018

(54) Photo Adapter

(71) Applicant: Leica Camera AG, Wetzlar (DE)

(72) Inventor: Sigrun KAMMANS, Herborn (DE)

(21) Appl. No.: 15/771,020

(22) PCT Filed: Oct. 25, 2016
(86) PCT No.: PCT/DE2016/100499

§ 371 Date: Apr. 25, 2018

(30) Foreign Application Priority Data
Oct. 26, 2015 (DE) 10 2015 118 250.5

(51) Int. Cl. G02B 23/14; G03B 17/56; G02B 23/16

(52) U.S. Cl. CPC G02B 23/14; G02B 23/16; G03B 17/565

(57) ABSTRACT

A photo adapter for attaching to the eyepiece of an optical magnification device having a diopter compensation apparatus, equipped with an apparatus for compensating the diopter compensation.

The invention relates to a photo adapter for attaching to the eyepiece of an optical magnification device having a diopter compensation apparatus.

Increasingly, cameras with interchangeable objective lenses are connected instead of the human eye behind the eyepieces of spotting scopes, telescopes, microscopes or measuring devices.

Document EP 2 674 811 A2 has disclosed an objective lens for an image-recording device, containing a housing for attaching to the eyepiece of a far-optical device and a connector to the image-recording device. Arranged in the housing is at least one lens for imaging an image produced by the far-optical device onto the image-recording device.

Document U.S. Pat. No. 6,069,651 A has disclosed an imaging system for endoscopes. A TV camera head with imaging optics and an image sensor can be attached to the eyepiece of an endoscope. An intermediate adapter that is displaceable along the optical axis can be inserted, for focusing purposes, between the endoscope eyepiece and the camera head.

The objective lenses of the cameras are optimized for a parallel incident beam path, i.e. for 0 diopter. Usually, they can be focused into the near region and then often still offer an acceptable imaging performance. This means that a myopic observer can compensate his eye's refractive error with the objective lens of the camera and can then switch between observation and image recording without, or with little, refocusing.

However, since a camera objective lens does not offer excess travel beyond infinity, or only very little excess travel at long focal lengths only, a hyperopic observer must always first of all set his observation device to 0 diopter in order to be able to make image recordings with the camera.

The invention was therefore based on the object of developing a photo adapter that, in a simple manner, facilitates the transition between observation and image recording, independently of the focal length of the camera objective lens.

According to the invention, this object is achieved in the case of a photo adapter of the type set forth at the outset by way of the characterizing features of claim 1 or 2. Advantageous configurations emerge from the features of the dependent claims.

Using the photo adapter according to the invention, it is possible to maintain the in-focus setting that was set at the observation device taking the individual refractive error into account and compensate the diopter settings by way of a objective lens with a fixed focal length that modifies the back focal length of the eyepiece of the observation device, combined with a sliding sleeve or an interchangeable compensation lens.

The compensation of the refractive error can be effectuated at the observation device, both by focusing at the objective lens and by setting the eyepiece. The extent of the individual refractive error in diopter values is known to the observer either from the diopter values of his spectacle lenses, as determined by an optician, and this can be compensated in the photo adapter by a corresponding change in the extension length of the sliding sleeve or by inserting a compensation objective lens with a focal length with the opposite sign.

In order to adapt the photo adapter to changing individual refractive errors, a combination of both solutions is also possible by virtue of the diopter setting that has been compensated by a fixed compensation lens in relation to a refractive error present additionally being compensated by an adjustment of the sliding sleeve.

If the diopter value is unknown, it can be measured by means of a diopter telescope, for example, or it can be ascertained in the case of a camera with a display depending on the change in the extension length of the sliding sleeve and the attachment thereof in the case of an in-focus setting. In any case, the necessary diopter compensation can be reproducibly set and fixed by way of the scale on the photo adapter.

By connecting the photo adapter to a clamping ring for attachment to the eyepiece of the observation device, there can be a simple change between observation and image recording without further focusing.

The focal length f of the objective lens inserted into the photo adapter is fixed and ascertained depending on the size of the sensor diagonal in the camera, on the size of the objective visual angle α of the observation device and on the magnification factor Γ. In the case of a modifiable magnification factor (zoom), the aim is to illuminate the image-recording sensor with the objective visual field for at least one magnification.

The objective visual angle α is the angle between the optical axis of the observation device and the edge of the observed visual field, and so the diameter of the visual field is determined by 2α. The focal length f of the objective lens in the photo adapter then emerges from

$$f = \frac{sensordiagonal}{magnificationfactor Γ * tan α}$$

In the case of far-optical observation devices, a typical value of f=30 mm±30% emerges.

The displacement length Δ when setting the sliding sleeve to the necessary diopter value emerges from

$$Δ = \frac{diopter value}{1000} * {f}^{2}$$

The maximum displacement path Δ is approximately 10 mm±30%.

The drawing schematically illustrates an exemplary embodiment of the photo adapter according to the invention and the latter is described in more detail below on the basis of the figures. In the figures:

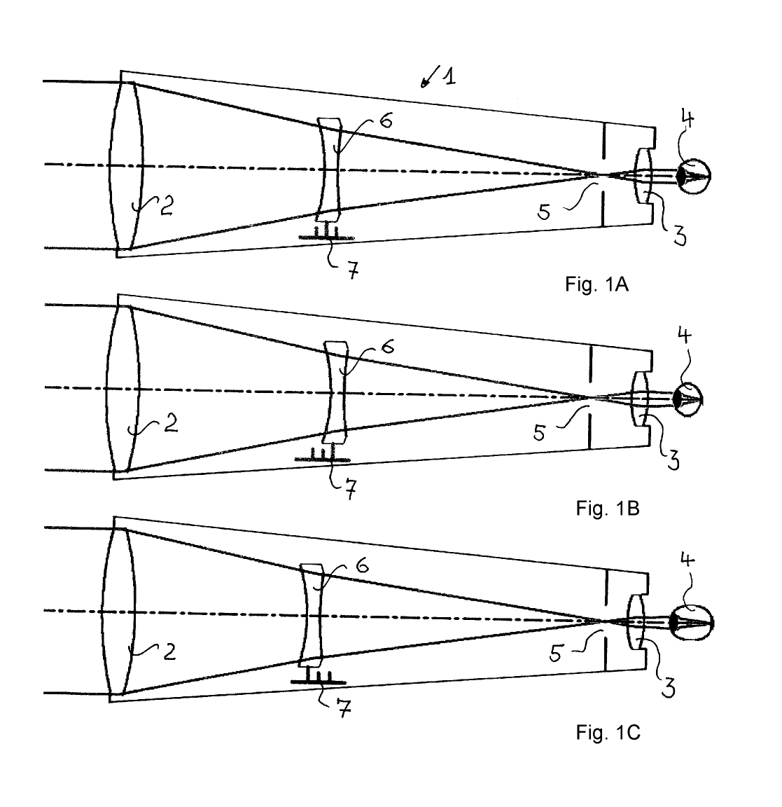

FIGS. 1A-1C show the diopter compensation at a telescope in the case of emmetropic, myopic and hyperopic observers,

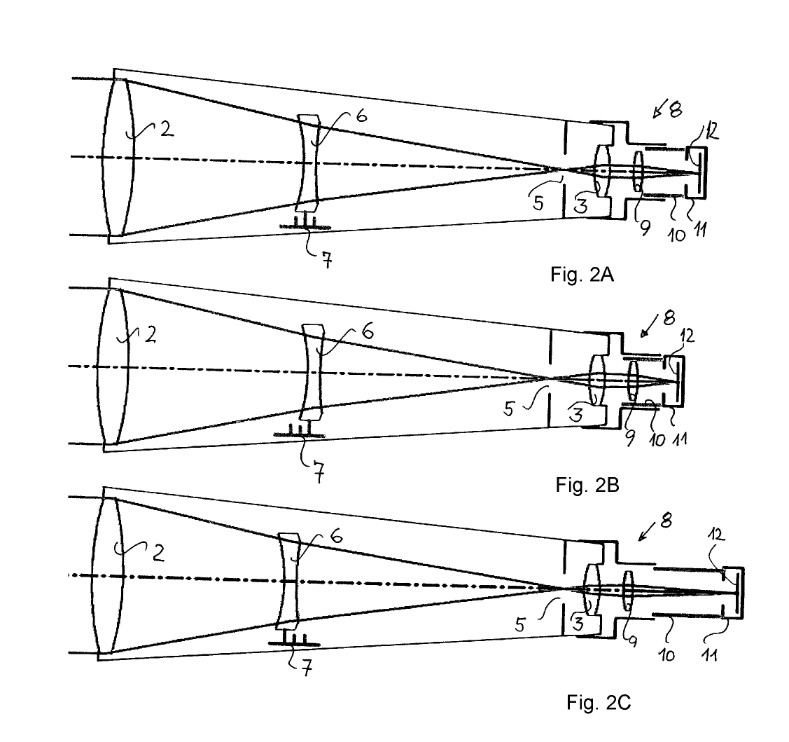

FIGS. 2A-2C show the photo adapter attached to an eyepiece of a telescope in correspondingly different extension lengths of the sliding sleeve,

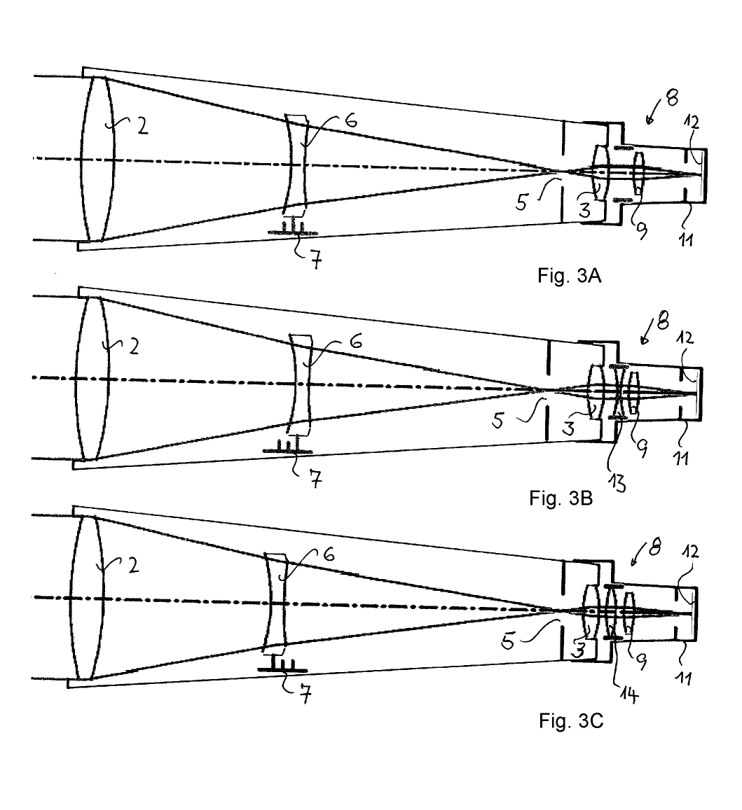

FIGS. 3A-3C show the insertion of an additional compensation lens upstream of the objective lens and

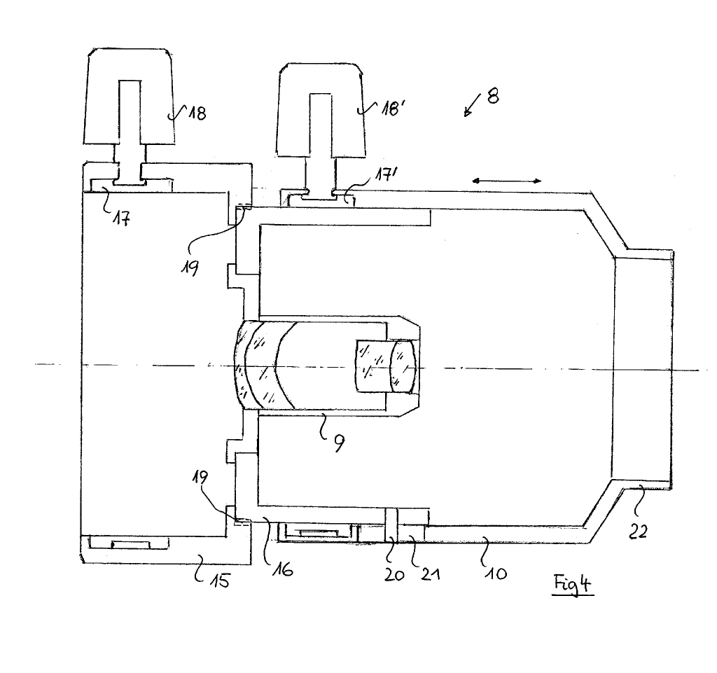

FIG. 4 shows a cross section through a photo adapter with a sliding sleeve for a telescope.

FIG. 1A schematically shows a telescope 1 with a telescope objective lens 2 and a telescope eyepiece 3. The image of the telescope produced in an intermediate image plane 5 is observed on the eyepiece side by way of the emmetropic eye 4. The rays for an image point emanating from the telescope eyepiece 3 run parallel to one another. An adjustable negative lens 6 symbolizes the adjustment possibility of the imaging system of the telescope 1 in relation to a scale 7 for diopter compensation that is required in the case of a refractive error of the eye 4.

FIG. 1B shows the course of the rays in the case of a myopic eye 4. For the purposes of an in-focus setting on the retina of the eye 4, the beam emerging from the telescope eyepiece 3 must be slightly convergent. This is produced by adjusting the negative lens 6 at the scale 7 into a position that is displaced toward the telescope eyepiece 3 and by repositioning the intermediate image plane 5 toward the telescope objective lens 2.

FIG. 1C shows the course of the rays in the case of a hyperopic eye 4. The beam emerging from the telescope eyepiece 3 must have a slightly divergent profile. This is produced by adjusting the negative lens 6 at the scale 7 into a position that is displaced toward the telescope objective lens 2 and by repositioning the intermediate image plane 5 toward the eyepiece 3.

FIG. 2A shows a photo adapter 8 with an adapter objective lens 9, a sliding sleeve 10, a camera housing 11 and a camera sensor 12, said photo adapter having been placed onto the eyepiece 3 of the telescope 1, instead of the eye 4. In the neutral position of the negative lens 6, the sliding sleeve 10 is situated in a mid-extension length and a new back focal length of the telescope eyepiece 3.

FIG. 2B shows the low pushed-in position of the sliding sleeve 10 with a shortened back focal length of the telescope eyepiece 3, which corresponds to a myopic eye 4.

FIG. 2C shows the greatly pulled out position of the sliding sleeve 10 with a lengthened back focal length of the telescope eyepiece 3, which corresponds to a hyperopic eye 4.

FIGS. 3A-3B show a photo adapter 8 without a sliding sleeve 10 but, in place thereof, with a compensation lens between the telescope eyepiece 3 and the adapter objective lens 9. A compensation lens with negative refractive power 13 is provided in FIG. 3B, corresponding to the diopter compensation in the case of a myopic eye 4, and a compensation lens with positive refractive power 14 is provided in FIG. 3C, corresponding to the diopter compensation in the case of a hyperopic eye 4.

FIG. 4 shows, in a cross section, a photo adapter 8 with cylindrical ring 15 for attachment to the eyepiece 3 of a telescope 1, adapter housing 16 with adapter objective lens 9 and sliding sleeve 10. The cylindrical ring 15 contains a clamping ring 17 with clamping screw 18, by means of which the cylindrical ring 15 can be fastened to the housing of a telescope eyepiece 3.

The cylindrical ring 15 is connected to the adapter housing 16 by way of a screw thread 19 or in any other way. An adapter objective lens 9 has been inserted in an immovable manner into the adapter 8. A sliding sleeve 10 is mounted on the adapter housing 16 in a longitudinally displaceable manner and said sliding sleeve can be fastened in any extension position by way of a clamping ring 17′ with clamping screw 18′. Preferably, the clamping screws 18, 18′ can be arranged with a 90° rotation in relation to one another.

At its free end, the sliding sleeve 10 is provided with a connector 22 for a camera housing 11. The connector may consist of a threaded screw or a bayonet.

Connected to the adapter 10, there is a pin 20 that slides in a slot 21 in the sliding sleeve 10. Attached to the slot 21 is a scale (not depicted in any more detail) for indicating the position of the pin 20 and hence the extension position of the sliding sleeve 10.

Instead of the linear longitudinal displacement of the sliding sleeve 10, a screwed adjustment or a curved guide are also possible, wherein, in place of the pin/slot indicator 20, 21, a corresponding marking should be provided between sliding sleeve 10 and adapter 16 in a manner similar to the distance setting in the case of photo objective lenses.

### LIST OF REFERENCE SIGNS

1 Telescope
2 Telescope objective lens
3 Telescope eyepiece
4 Eye
5 Intermediate image plane
6 Negative lens
7 Scale
8 Photo adapter
9 Adapter objective lens
10 Sliding sleeve
11 Camera housing
12 Image-recording sensor
13 Compensation lens with negative refractive power
14 Compensation lens with positive refractive power
15 Cylindrical ring
16 Adapter housing
17, 17′ Clamping ring
18, 18′ Clamping screw
19 Screw thread
20 Pin
21 Slot
22 Connector for camera housing

1. A photo adapter for attaching to the eyepiece of an optical magnification device having a diopter compensation apparatus, equipped with an apparatus for compensating the diopter compensation, comprising:
a) an adapter objective lens with a fixed focal length f that modifies the back focal length of the eyepiece and that has been inserted into the photo adapter in an immovable manner; and
b) a displaceable sleeve with connector for a camera housing with image-recording sensor, configured to compensate the back focal length change, wherein
c) a scale displaying the displacement length Δ in diopter units dpt is attached to an adapter housing.

2. A photo adapter for attaching to the eyepiece of an optical magnification device having a diopter compensation apparatus, equipped with an apparatus for compensating the diopter compensation, comprising:
a) an adapter objective lens with a fixed focal length f that modifies the back focal length of the eyepiece and that has been inserted into the photo adapter in an immovable manner, wherein
b) the adapter contains a slide-in compartment for a compensation lens upstream of the adapter objective lens in the light direction and
c) the focal length of the compensation lens equals the value with opposite sign of the focal length change of the magnification device that is required for the diopter compensation.

3. The photo adapter as claimed in claim 1, wherein the focal length f of the adapter objective lens is determined depending on the size of the diagonal of the image-recording sensor, the visual field diameter 2α and the magnification factor Γ of the magnification device according to
f=sensor diagonal/(magnification factor×tan α).

4. The photo adapter as claimed in claim 3, wherein the focal length is f=30 mm±30%.

5. The photo adapter as claimed in claim 1, wherein the displacement length Δ is determined by
$$Δ = \frac{diopter value}{1000} * {f}^{2} .$$

6. The photo adapter as claimed in claim 2, wherein the focal length f of the adapter objective lens is determined depending on the size of the diagonal of the image-recording sensor, the visual field diameter 2α and the magnification factor Γ of the magnification device according to
f=sensor diagonal/(magnification factor×tan α).

7. The photo adapter as claimed in claim 6, wherein the focal length is f=30 mm±30%.
